(19) United States
(12) Patent Application Publication
(10) Pub. No.: US 2006/0196893 A1
(43) Pub. Date: Sep. 7, 2006

(54) Venting closure for a container

(76) Inventor: Valentin Hierzer, Arlington Heights, IL (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 11/074,346

(22) Filed: Mar. 7, 2005

(51) Int. Cl. B67D 3/00

(52) U.S. Cl. 222/481

(57) ABSTRACT

A closure for a container includes a main body portion that is constructed and arranged to be secured to a container, such as by a threaded engagement. The main body portion has a dispensing orifice defined therein that is configured to permit material flow from the container. A lid portion is hingedly mounted to the main body portion and is movable between a first, open position wherein material may be dispensed from the container through the dispensing orifice and a second, closed position wherein the dispensing orifice is blocked by the lid portion. Venting structure is defined in the main body portion for permitting for permitting outside air to enter the container when an underpressure condition exists within the container, as may be expected to occur when the container is subjected to a change in altitude or temperature.

### BACKGROUND OF THE INVENTION

1. Field of the Invention

This invention relates to a closure assembly for containers, and more particularly to a closure assembly which can vent to allow atmospheric air to enter the container under certain conditions but prevents the passage of the contents therefrom.

2. Description of the Related Technology

Many flowable products such as comestibles, lotions and soaps are conveniently and economically packaged using plastic containers. If the flowable product is warm when admitted into the container and the container is sealed, an underpressure may be expected to develop within the container as the product and the container subsequently cools. This effect can also occur if the containers are filled at a high altitude manufacturing facility and subsequently shipped to sea level for distribution and sale.

Due to the flexible nature of such plastic containers, their shape will tend to distort or collapse under this differential pressure and present an unsightly appearance to the consumer. The amount of such distortion is affected by the size and shape of the bottles and the composition and thickness of the plastic resin used for the bottle walls as well as by the magnitude of the pressure differential.

Container collapse is a well-known issue in this area of technology that previous efforts have been made to address. Such efforts have largely concentrated on controlling the flow of atmospheric air between the interengaging threads of the closure and the container and over the rim of the container finish. Specifically, some prior art closure designs have included a gasket support flange oppositely disposed to the rim of the container finish that have small axial gaps defined therein for admitting air to the container. However, the presence of such gaps creates the possibility of product leakage from the container, a possibility that is unacceptable to the manufacturers of many products.

A need exists for an improved venting dispensing closure that facilitates the admission of atmospheric air when an underpressure condition exists within the container, but that ensures that the product will not be permitted to escape from the container, particularly while the closure remains unopened.

### SUMMARY OF THE INVENTION

Accordingly, it is an object of the invention to provide an improved venting closure that facilitates the admission of atmospheric air when an underpressure condition exists within the container, but that ensures that the product will not be permitted to escape from the container, particularly while the closure remains unopened.

In order to achieve the above and other objects of the invention, a dispensing closure for a container that is constructed according to a first aspect of the invention includes a main body portion that is constructed and arranged to be secured to a container, the main body portion having a dispensing orifice defined therein; a lid portion, the lid portion being hingedly mounted to the main body portion and being movable between a first, open position wherein material may be dispensed from the container through said orifice and a second, closed position wherein the dispensing orifice is blocked by the lid portion; and venting structure defined in the main body portion for permitting outside air to enter the container when an underpressure condition exists within the container.

A dispensing closure for a container that is constructed according to a second aspect of the invention includes a main body portion that is constructed and arranged to be secured to a container, the main body portion having a dispensing orifice defined therein; a control element movably mounted with respect to the main body portion and being movable between a first position wherein material may be dispensed from the container through the orifice and a second position wherein material is prevented from flowing through the dispensing orifice; and venting structure for permitting outside air to enter the container when an underpressure condition exists within the container, the venting structure being constructed and arranged to prevent material from the container flowing outwardly therethrough when the control element is in the second position.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of the closure that is constructed according to a preferred embodiment of the invention, shown in a open position;

FIG. 2 is a cross-sectional view of the closure shown in FIG. 1, shown in the open position;

FIG. 3 is a cross-sectional view similar to that shown in FIG. 2, with the closure being depicted in the closed position; and

FIG. 4 is a cross-sectional view providing an enlargement of a portion of the closure that is shown in FIG. 2.

### DETAILED DESCRIPTION OF THE PREFERRED EMBODIMENT(S)

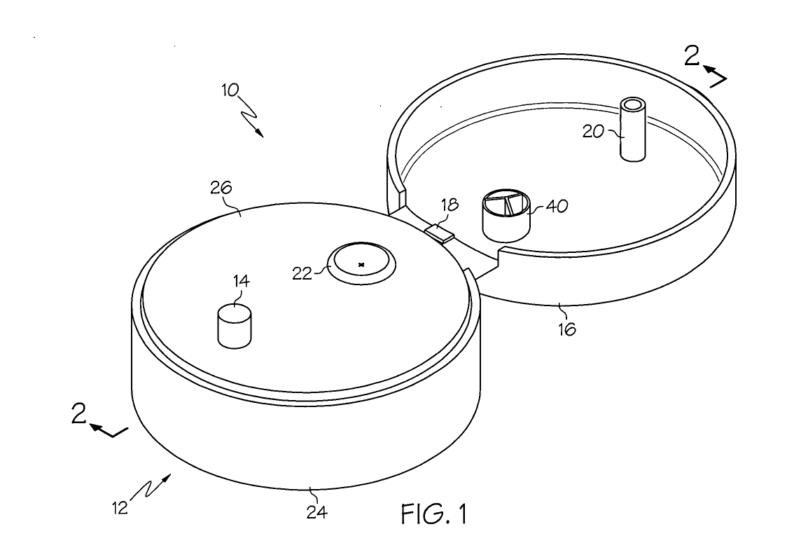

Referring now to the drawings, wherein like reference numerals designate corresponding structure throughout the views, and referring in particular to FIG. 1, a dispensing closure 10 that is constructed according to a preferred embodiment of the invention includes a main body portion 12 that is adapted to be secured to a container. Main body portion 12 may be constructed so as to be screwable onto a threaded finish portion of the container; it may be constructed as a snap fit closure, or through any conventional alternative mode of securement.

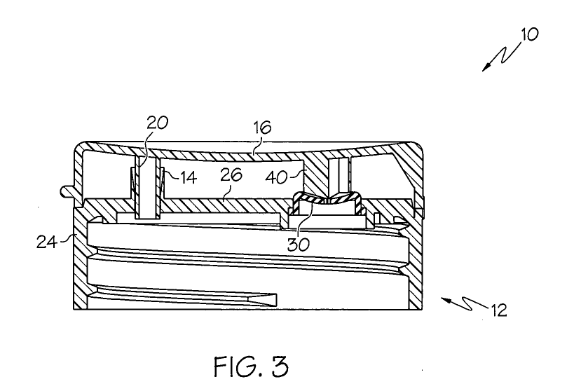

Closure 10 includes a conventional dispensing orifice 14 and a lid portion 16 that is hingedly mounted with respect to the main body portion 12 by an integral hinge 18. A plug member 20 is provided integral with the underside of the lid portion 16 for sealing the dispensing orifice 14 when the closure is in the closed position, as is best shown in FIG. 3. As will be described in greater detail below, one particularly advantageous feature of the invention is the provision of venting structure 22 that is constructed to permit outside air to enter the container when an underpressure condition exists within the container. Venting structure 22 is preferably positioned between the dispensing orifice 14 and the hinge member 18 on the closure 10.

Main body portion 12 includes, as is conventional, a downwardly depending skirt portion 24 and a substantially horizontal top deck portion 26. Dispensing orifice 14 is preferably defined in an upstanding spout that is unitary with the top deck portion 26. In addition, the venting structure 22 is preferably defined in the top deck portion 26.

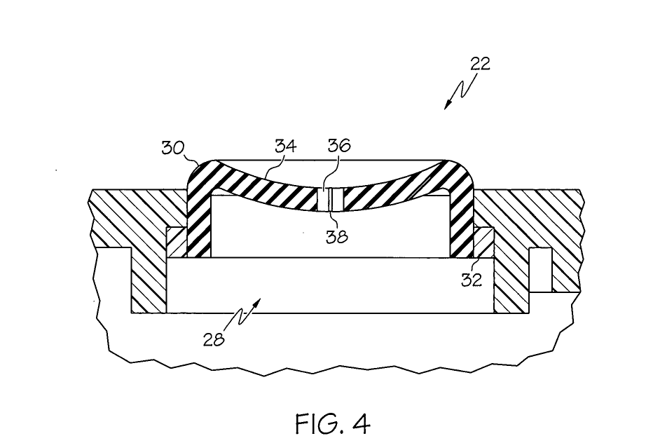

FIG. 4 provides a close-up cross-sectional view of the venting structure 22 according to the preferred embodiment of the invention. A substantially circular venting opening 28 is defined in the top deck portion 26 of the main body portion 12 of the closure 10. A prefabricated valve member is mounted within the venting opening 28 that includes an elastomeric membrane 30 that is securely attached to a rigid mounting flange 32 that is seated against an underside of the top deck portion 26. Elastomeric membrane 30 is preferably fabricated from an elastomeric material such as a thermoplastic Elastomer (TPE) or another material having equivalent characteristics and properties. Rigid mounting flange 32 is preferably fabricated from a plastic material that is harder than the material from which elastomeric membrane 30 is fabricated, such as polypropylene.

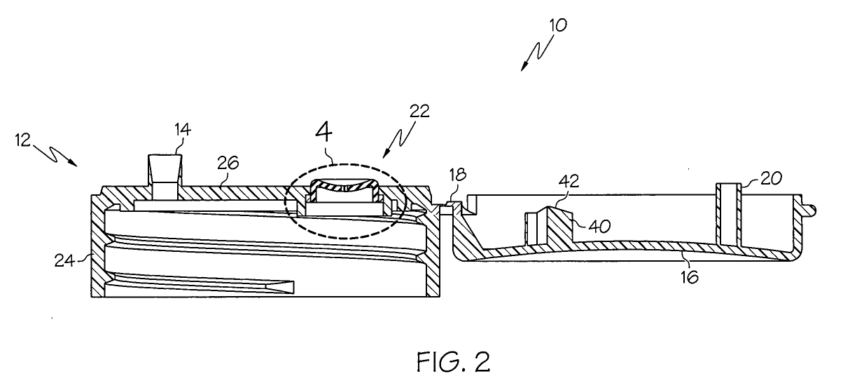

Elastomeric membrane 30 includes a central portion having an upwardly concave area 34 in which a plurality of flap members 36 are defined by a corresponding plurality of slits 38 in the elastomeric membrane 30. By virtue of the upwardly concave configuration of the central portion of the elastomeric membrane 30, these resilient flap members 36 are inherently biased against upward deflection such as which would be necessary for air or liquid to exit the container through the prefabricated valve member. It is particularly important that no such leakage from the container occurs when the closure is in the closed position. In order to prevent upward deflection of the flap members when the lid portion 16 is in the closed position, a downwardly depending spud member 40 is provided integral with the underside of the lid portion 16, as is best shown in FIGS. 2 and 3. Spud member 40 preferably has a generally convex distal surface 42 that is designed to be in contact with or be positioned immediately adjacent to the upper surface of the upwardly concave portion 34 of the elastomeric membrane 30 of the prefabricated valve member when the lid portion 16 is in the closed position.

In the event that the closure 10 is assembled onto a container under high-altitude conditions and the container assembly is subsequently moved to an environment in which the ambient air pressure is higher, replacement air will be permitted to enter the container through the prefabricated valve member by inducing downward displacement of the resilient flap members 36, even when the closure 10 remains in the closed position. However, as described above, upward deflection of the flap members 36 will be prevented so that the contents of the container will be prevented from escaping through the prefabricated valve member when the closure is closed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A dispensing closure for a container, comprising:
a main body portion that is constructed and arranged to be secured to a container, said main body portion having a dispensing orifice defined therein;
a lid portion, said lid portion being hingedly mounted to said main body portion and being movable between a first, open position wherein material may be dispensed from the container through said orifice and a second, closed position wherein said dispensing orifice is blocked by said lid portion; and
venting means defined in said main body portion for permitting outside air to enter the container when an underpressure condition exists within the container.

2. A dispensing closure for a container according to claim 1, wherein said venting means is constructed and arranged to prevent material within the container from passing therethrough when said lid portion is in said second, closed position.

3. A dispensing closure for a container according to claim 1, wherein said main body portion comprises a downwardly depending skirt portion and a horizontally oriented top deck portion, and wherein said dispensing orifice is defined in said horizontally oriented top deck portion.

4. A dispensing closure for a container according to claim 3, wherein said venting means is also defined in said horizontally oriented top deck portion.

5. A dispensing closure for a container according to claim 4, wherein said venting means comprises a venting opening defined in said horizontally oriented top deck portion and at least one resilient flap member positioned in said venting opening, said flap member being constructed and arranged to deflect downwardly when an underpressure exists in the container, thereby permitting outside air to flow through said venting opening.

6. A dispensing closure for a container according to claim 5, further comprising limiting means for preventing upward deflection of said flap member when said lid portion is in said second, closed position.

7. A dispensing closure for a container according to claim 6, wherein said limiting means comprises a downwardly depending spud portion that is integral with said lid portion, said spud portion being positioned immediately adjacent to an upper surface of said flap member when said lid portion is in said second, closed position.

8. A dispensing closure for a container according to claim 5, wherein said venting means comprises a plurality of said resilient flap members.

9. A dispensing closure for a container according to claim 8, wherein said main body portion is fabricated from a relatively rigid plastic material, and wherein said resilient flap members are fabricated from a resilient elastomeric material that is more elastic than said relatively rigid plastic material.

10. A dispensing closure for a container according to claim 8, wherein said plurality of resilient flap members are defined by a single elastomeric membrane having a plurality of slits defined therein.

11. A dispensing closure for a container according to claim 10, wherein said elastomeric membrane is configured so as to be upwardly concave, whereby said resilient flap members are biased against upward deflection.

12. A dispensing closure for a container according to claim 1, wherein said venting means comprises a venting opening defined in said main body portion and a prefabricated valve member positioned within said venting opening.

13. A dispensing closure for a container according to claim 12, wherein said prefabricated valve member is biased to discourage material flowing therethrough out of the container.

14. A dispensing closure for a container according to claim 1, further comprising a hinge member mounting said lid portion for pivotal movement with respect to said main body portion, and wherein said venting means is positioned between said dispensing orifice and said hinge member.

15. A dispensing closure for a container, comprising:
a main body portion that is constructed and arranged to be secured to a container, said main body portion having a dispensing orifice defined therein;
a control element movably mounted with respect to said main body portion and being movable between a first position wherein material may be dispensed from the container through said orifice and a second position wherein material is prevented from flowing through said dispensing orifice; and
venting means for permitting outside air to enter the container when an underpressure condition exists within the container, said venting means being constructed and arranged to prevent material from the container flowing outwardly therethrough when said control element is in said second position.

16. A dispensing closure for a container according to claim 15, wherein said venting means is further biased to discourage material flowing therethrough out of the container when said control element is in said first position.

17. A dispensing closure for a container according to claim 15, wherein said venting means comprises a venting opening defined in said main body portion and a prefabricated valve member positioned within said venting opening.

18. A dispensing closure for a container according to claim 15, wherein said venting means comprises a venting opening defined in said main body portion and at least one resilient flap member positioned in said venting opening, said flap member being constructed and arranged to deflect downwardly when an underpressure exists in the container, thereby permitting outside air to flow through said venting opening.

19. A dispensing closure for a container according to claim 18, wherein said venting means further comprises limiting means for preventing upward deflection of said flap member when said control element is in said second position.

20. A dispensing closure for a container according to claim 18, wherein said venting means comprises a plurality of said resilient flap members.

21. A dispensing closure for a container according to claim 20, wherein said main body portion is fabricated from a relatively rigid plastic material, and wherein said resilient flap members are fabricated from a resilient elastomeric material that is more elastic than said relatively rigid plastic material.

22. A dispensing closure for a container according to claim 20, wherein said plurality of resilient flap members are defined by a single elastomeric membrane having a plurality of slits defined therein.

23. A dispensing closure for a container according to claim 22, wherein said elastomeric membrane is configured so as to be upwardly concave, whereby said resilient flap members are biased against upward deflection.
